(19) United States
(12) Patent Application Publication
(10) Pub. No.: US 2026/0093880 A1
(43) Pub. Date: Apr. 2, 2026

(54) System and Method for Automatic Data Library Creation Associated with an Electronic Design

(71) Applicant: Cadence Design Systems, Inc., San Jose, CA (US)

(72) Inventors: Hanish Wadhawan, Delhi (IN); Pratibha Shekhawat, Muradnagar Ghaziabad (IN); Naina Dandona, Mahagun Moderne (IN); Jasmine Dhody, Noida (IN)

(21) Appl. No.: 18/899,333

(22) Filed: Sep. 27, 2024

(51) Int. Cl. G06F 30/31; G06F 111/20

(52) U.S. Cl. CPC G06F 30/31; G06F 2111/20

(57) ABSTRACT

Systems and methods for electronic design are provided. Embodiments may include receiving, at a graphical user interface, a user input related to a library data model and analyzing a trained machine learning model based upon, at least in part, the user input. Embodiments may further include providing, at the graphical user interface, one or more recommendations for the user input and receiving, at the graphical user interface, a first selection of the one or more recommendations.

### BACKGROUND

Some existing technologies involve designing and verifying an electronic design, such as the design of an integrated circuit (IC). Modern electronic design is typically performed with computer aided design (CAD) tools or electronic design automation (EDA) systems. To design an integrated circuit, a designer first creates high level behavior descriptions of the IC device using a high-level hardware design language (HDL). Common examples of HDLs include Verilog and VHDL. An EDA system typically receives the high-level behavioral descriptions of the IC device and translates this high-level design language into netlists of various levels of abstraction. Essentially, the process to implement an electronic device begins with functional design and verification (e.g., using RTL), and then proceeds to physical design and verification.

Many EDA systems involve library creation, which is the first step in EDA printed circuit board (PCB) or IC development. Different types of library data models like part models, schematic models, footprint models, padstack models, step models and documentation models etc. may all be combined together to form a library. Despite being the first step in EDA system design flow, creating library data models has always been a tedious and error-prone process due to the involvement of high and varying attributes and complex graphics with different stylings. This takes up weeks and even months for creating complex parts.

### SUMMARY

In one or more embodiments of the present disclosure, a computer-implemented method for electronic design is provided. The method may include receiving, at a graphical user interface, a user input related to a library data model and analyzing a trained machine learning model based upon, at least in part, the user input. The method may further include providing, at the graphical user interface, one or more recommendations for the user input and receiving, at the graphical user interface, a first selection of the one or more recommendations.

One or more of the following features may be included. In some embodiments, the method may further include generating a new data model based upon, at least in part, the selection. The library data model may be a graphical data model and/or a non-graphical data model. The user input may be a textual input and/or a graphical input. The method may further include receiving, at the graphical user interface, a second selection of a second of the one or more recommendations. The first selection and the second selection may be from different library models. The one or more recommendations may be displayed in an order of prioritized relevancy. The method may further include providing, at the graphical user interface, an option to reject a proposed recommendation to provide negative feedback. The library data model may be at least one of a front-end model or a back-end model. The method may further include retraining the machine learning model based upon, at least in part, the first selection. The method may also include providing, at the graphical user interface, an option to purge redundant data.

In another embodiment of the present disclosure a system for electronic design is provided. The system may include at least one processor configured to cause receiving, at a graphical user interface, a user input related to a library data model. The at least one processor may be further configured to analyze a trained machine learning model based upon, at least in part, the user input and to provide, at the graphical user interface, one or more recommendations for the user input. The at least one processor may be further configured to cause receiving, at the graphical user interface, a first selection of the one or more recommendations.

One or more of the following features may be included. In some embodiments, the method may further include generating a new data model based upon, at least in part, the selection. The library data model may be a graphical data model and/or a non-graphical data model. The user input may be a textual input and/or a graphical input.

In yet another embodiment of the present disclosure a non-transitory computer readable storage medium having stored thereon one or more instructions, which when executed by a processor result in one or more operations is provided. The operations may include receiving, at a graphical user interface, a user input related to a library data model and analyzing a trained machine learning model based upon, at least in part, the user input. Operations may further include providing, at the graphical user interface, one or more recommendations for the user input and receiving, at the graphical user interface, a first selection of the one or more recommendations.

Additional features and advantages of embodiments of the present disclosure will be set forth in the description which follows, and in part will be apparent from the description, or may be learned by practice of embodiments of the present disclosure. The objectives and other advantages of the embodiments of the present disclosure may be realized and attained by the structure particularly pointed out in the written description and claims hereof as well as the appended drawings.

It is to be understood that both the foregoing general description and the following detailed description are exemplary and explanatory and are intended to provide further explanation of embodiments of the invention as claimed.

### BRIEF DESCRIPTION OF THE DRAWINGS

The drawings illustrate the design and utility of various embodiments of the invention. It should be noted that the figures are not drawn to scale and that elements of similar structures or functions are represented by like reference numerals throughout the figures. In order to better appreciate how to obtain the above-recited and other advantages and objects of various embodiments of the invention, a more detailed description of the present inventions briefly described above will be rendered by reference to specific embodiments thereof, which are illustrated in the accompanying drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a distributed system diagram including a library creation process consistent with embodiments of the present disclosure;

FIG. 2 illustrates a flowchart depicting operations consistent with embodiments of a library creation process of the present disclosure;

FIGS. 3-4 illustrate graphical user interfaces consistent with embodiments of the present disclosure;

FIG. 5 illustrates exemplary pseudocode consistent with embodiments of the present disclosure;

FIG. 6 illustrates a diagram consistent with embodiments of the present disclosure;

FIGS. 7-8 illustrate graphical user interfaces consistent with embodiments of the present disclosure;

FIGS. 9-12 illustrate diagrams consistent with embodiments of the present disclosure;

FIGS. 13-17 illustrate flowcharts consistent with embodiments of the present disclosure;

FIG. 18 show a diagram consistent with embodiments of the present disclosure;

FIG. 19 illustrates a flowchart consistent with embodiments of the present disclosure; and

FIG. 20 illustrates a system diagram that may be used to implement one or more embodiments.

### DETAILED DESCRIPTION

As discussed above, different types of library data models like part models, schematic models, footprint models, padstack models, step models and documentation models etc. may all be combined together to form a library. Despite being the first step in EDA system design flow, creating library data models has always been a tedious and error-prone process due to the involvement of high and varying attributes and complex graphics with different stylings. This takes up weeks and even months for creating complex parts. These models may be either graphical or non-graphical. For example, schematic, footprint, padstack models may be graphical, while part models that contain only text attributes and linked models are non-graphical. These data models may be consumed in schematic designing tools followed by floor planning, layout generation, testing and PCB manufacturing tools.

Despite being the first step in EDA system design flow, creating library data models has always been a tedious and error-prone process due to involvement of high and varying attributes and complex graphics with different stylings. This takes up weeks and even months for creating complex parts.

Extracting attributes of library data models from datasheets may be a tedious and time-consuming process. Existing approaches fail to address library authoring, which eases the task of a librarian by using an automatic recommendation system while creating new models to bring down creation time to seconds and at most minutes from days. Accordingly, embodiments included herein provide a method that helps the librarians with an automatic recommendation solution based on available library data models in their ecosystem. Customers have huge sets of library data models already available, which may be used by embodiments included herein to generate various types of new models. As is discussed in further detail hereinbelow, embodiments of the present disclosure may receive one or more user inputs in a natural language and recommend the most relevant attributes for the new model.

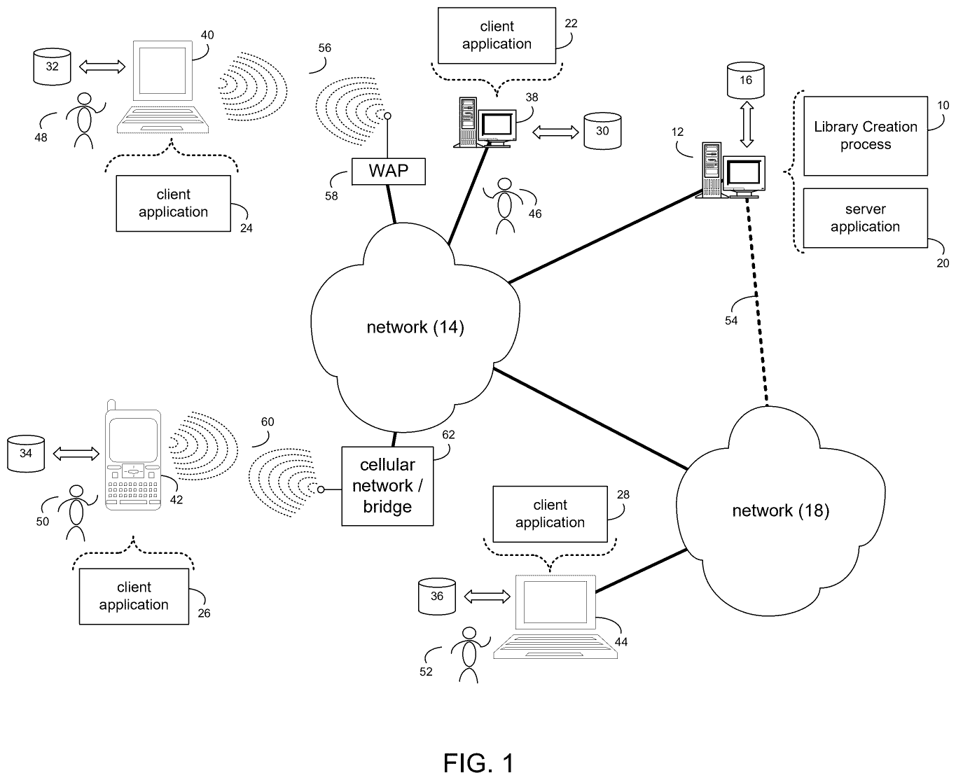

Various embodiments of the methods, systems, and articles of manufacture will now be described in detail with reference to the drawings, which are provided as illustrative examples of the invention so as to enable those skilled in the art to practice the invention. Notably, the figures and the examples below are not meant to limit the scope of various embodiments, unless otherwise specifically described in particular embodiment(s) or recited in the claim(s). Where certain elements of embodiments may be partially or fully implemented using known components (or methods or processes), portions of such known components (or methods or processes) that are necessary for an understanding of the present invention will be described, and the detailed descriptions of other portions of such known components (or methods or processes) will be omitted for ease of explanation and to not obscure embodiments of the invention. Further, embodiments encompass present and future known equivalents to the components referred to herein by way of illustration. More details about various processes or modules to implement various embodiments are further described below with reference to FIGS. 1-19.

Referring to FIG. 1, there is shown a library creation process 10 that may reside on and may be executed by server computer 12, which may be connected to network 14 (e.g., the internet or a local area network). Examples of server computer 12 may include, but are not limited to: a personal computer, a server computer, a series of server computers, a minicomputer, and a mainframe computer. Server computer 12 may be a web server (or a series of servers) running a network operating system, examples of which may include but are not limited to: Microsoft Windows XP Server™; Novell Netware™; or Redhat Linux™, for example. Additionally, and/or alternatively, library creation process 10 may reside on a client electronic device, such as a personal computer, notebook computer, personal digital assistant, or the like.

The instruction sets and subroutines of library creation process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random-access memory (RAM); and a read-only memory (ROM).

Server computer 12 may execute a web server application, examples of which may include but are not limited to: Microsoft IIS™, Novell Webserver™, or Apache Webserver™, which allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more server applications (e.g., server application 20), examples of which may include but are not limited to, e.g., Lotus Domino™ Server and Microsoft Exchange™ Server. Server application 20 may interact with one or more client applications (e.g., client applications 22, 24, 26, 28) in order to execute library creation process 10. Examples of client applications 22, 24, 26, 28 may include, but are not limited to, design verification tools such as those available from the assignee of the present disclosure. These applications may also be executed by server computer 12. In some embodiments, library creation process 10 may be a stand-alone application that interfaces with server application 20 or may be an applet/application that is executed within server application 20.

The instruction sets and subroutines of server application 20, which may be stored on storage device 16 coupled to server computer 12, may be executed by one or more processors (not shown) and one or more memory architectures (not shown) incorporated into server computer 12.

As mentioned above, in addition/as an alternative to being a server-based application residing on server computer 12, the library creation process may be a client-side application residing on one or more client electronic devices 38, 40, 42, 44 (e.g., stored on storage devices 30, 32, 34, 36, respectively). As such, the library creation process may be a stand-alone application that interfaces with a client application (e.g., client applications 22, 24, 26, 28), or may be an applet/application that is executed within a client application. As such, the library creation process may be a client-side process, a server-side process, or a hybrid client-side/server-side process, which may be executed, in whole or in part, by server computer 12, or one or more of client electronic devices 38, 40, 42, 44.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, personal computer 38, laptop computer 40, personal digital assistant 42, notebook computer 44, a data-enabled, cellular telephone (not shown), and a dedicated network device (not shown), for example. Using client applications 22, 24, 26, 28, users 46, 48, 50, 52 may utilize formal analysis, testbench simulation, and/or hybrid technology features to verify and/or simulate a particular integrated circuit design.

Users 46, 48, 50, 52 may access server application 20 directly through the device on which the client application (e.g., client applications 22, 24, 26, 28) is executed, namely client electronic devices 38, 40, 42, 44, for example. Users 46, 48, 50, 52 may access server application 20 directly through network 14 or through secondary network 18. Further, server computer 12 (e.g., the computer that executes server application 20) may be connected to network 14 through secondary network 18, as illustrated with phantom link line 54.

In some embodiments, library creation process 10 may be a cloud-based process as any or all of the operations described herein may occur, in whole, or in part, in the cloud or as part of a cloud-based system. The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (CSMA/CA) for path sharing. The various 802.11x specifications may use phase-shift keying (PSK) modulation or complementary code keying (CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, Apple iOS, ANDROID, or a custom operating system.

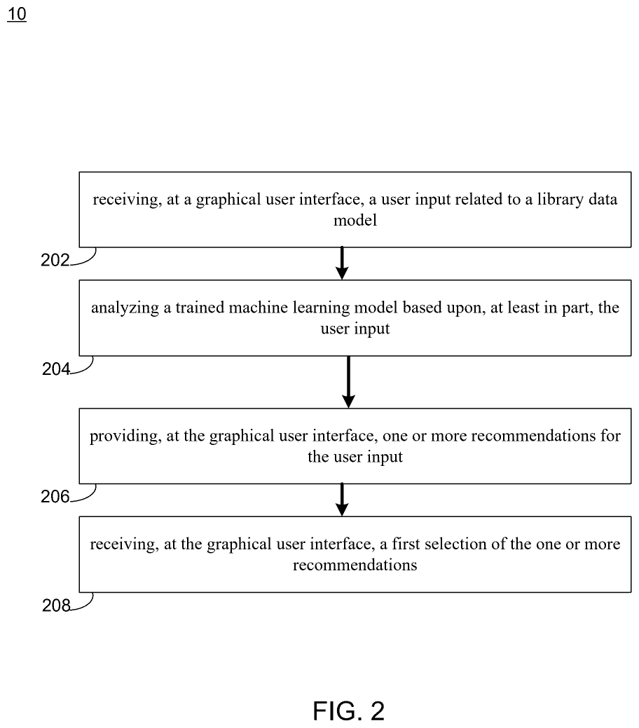

Referring now to FIG. 2, a flowchart depicting an embodiment in accordance with library creation process 10 is provided. The process may include receiving (202), at a graphical user interface, a user input related to a library data model and analyzing (204) a trained machine learning model based upon, at least in part, the user input. The method may further include providing (206), at the graphical user interface, one or more recommendations for the user input and receiving (208), at the graphical user interface, a first selection of the one or more recommendations. Numerous other operations are also within the scope of the present disclosure.

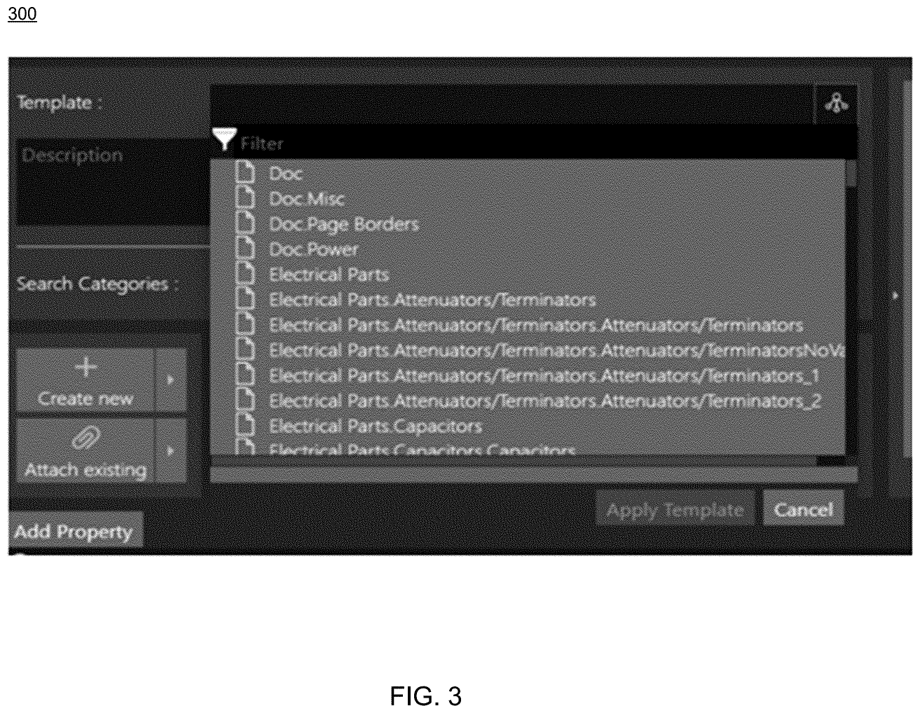

Referring now to FIG. 3, an example graphical user interface 300 consistent with embodiments of the present disclosure is provided. Graphical user interface 300 depicts an example of templates-based library data model creation in EDA applications allowing library designers to create templates for library data models that they can reuse later. The creation of library templates require equivalent efforts as library data model creation making this process as time consuming as the original problem. The number of templates that may be created may be limited. As such, every required piece of re-usable information might not be existing in the form of a template. To cater to a variety of library data models, a long list of templates may be required leading to higher browsing times and added complexity in choosing the right one.

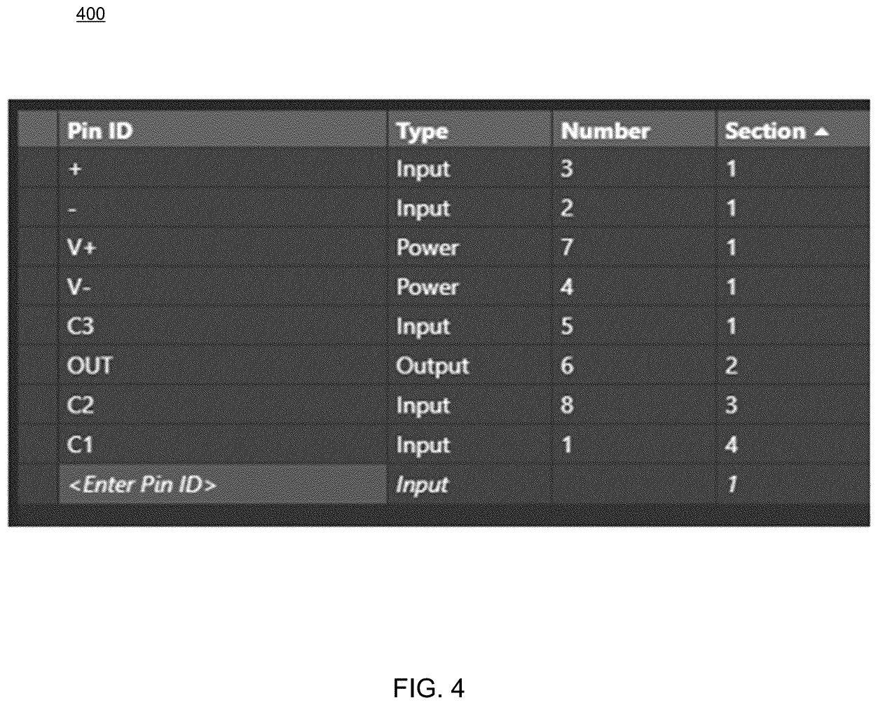

Referring now to FIG. 4, an example graphical user interface 400 consistent with embodiments of the present disclosure is provided. Graphical user interface 400 depicts an example of copy-paste data into library creator tools. However, this approach may require filtering and reorganizing source data to be pasted in the required format in target system. This approach may need a large amount of verification steps to ensure the pasted data is same as source data as target system might change data values based on supported data values. Individual exhaustive methods may need to be employed to copy different categories of data, for example, text, graphics etc. For example, graphical data may need to be pasted on canvas, textual data needs to be pasted in tabular grid as shown in image. There are a range of challenges in a copy-paste model. Some of these include, but are not limited to, the idea that data for Library Data Models is generally existing in datasheets (e.g., a PDF file). Datasheets have the relevant data for library data model scattered across different pages of this PDF file. Collecting this data is itself a challenging task. Moreover, data is often also existing in excel or CSV files. Different data sources have different format of data. When a user copies a table from a PDF file, two column values may be separated by a ‘whitespace’ just a single space, whereas, when data is copied from excel or CSV, four whitespaces separate two column values. Additionally, copied data comes in clipboard and it may be impossible to identify where the data is coming from until and unless the source tool embeds that information in clipboard which dissolves the whole purpose of clipboard. As such, the target tool may not have any means to know what is the source of data and hence whether to treat one or four whitespaces as a new column resulting in mismatch between source and target data.

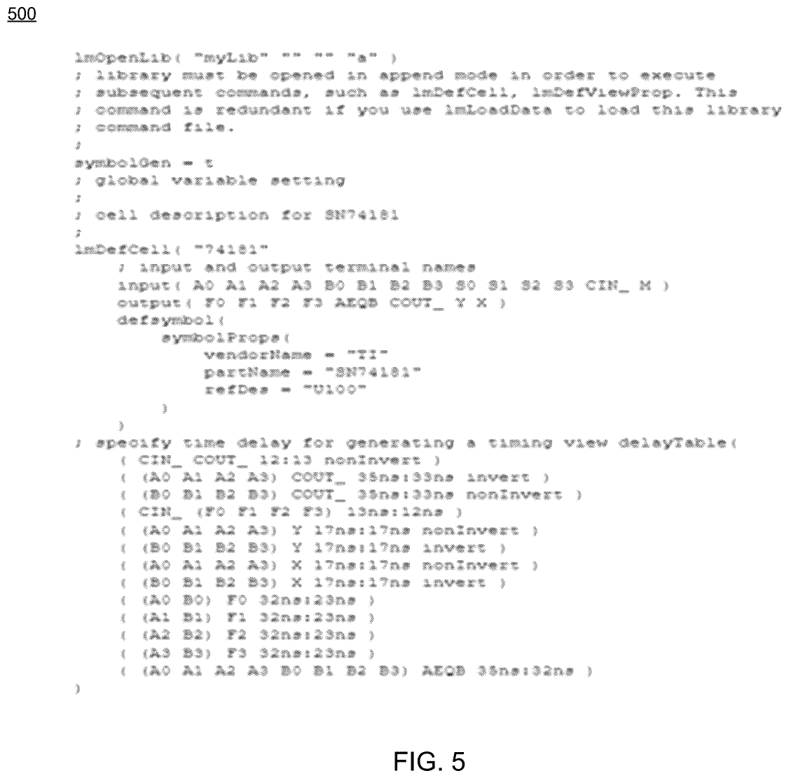

Referring now to FIG. 5, an example of pseudocode 500 consistent with embodiments of the present disclosure is provided. Non-graphical command file-based library generation in some EDA applications easing down creation of libraries and symbols efforts and producing better accuracy than graphical methods. However, the creation of library command files requires equivalent efforts. Some applications may allow for text (CSV, JSON) based library data models creation. However, these approaches may require manual efforts and the creation from scratch may lead to more errors.

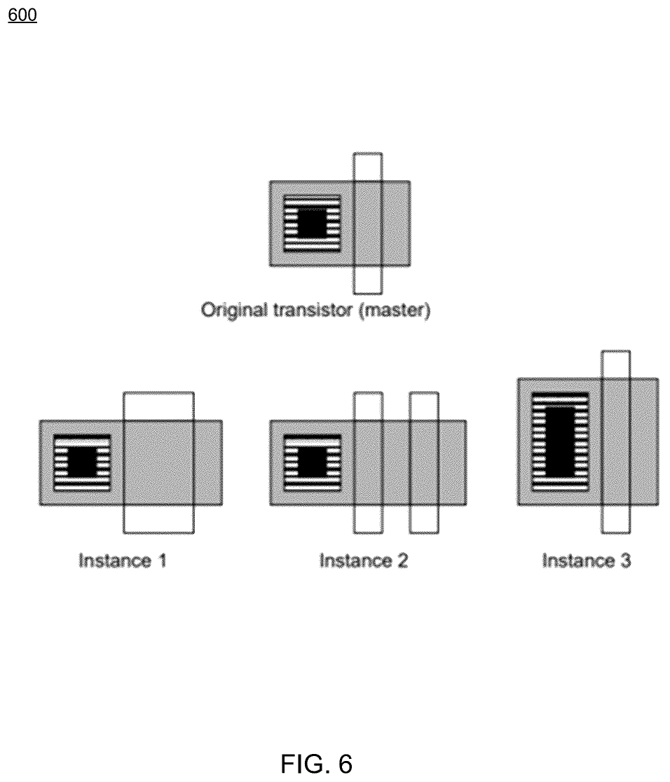

Referring now to FIG. 6, an example diagram 600 consistent with embodiments of the present disclosure is provided. Diagram 600 shows an example of parameterized cell creation promoting run-time creation of cell instances from a master cell with run-time and inherited parameters. However, this approach is a template-based approach with added value as it provides run-time parameterization of cell instances but creating master cells again require additional efforts as information needs to be collected for creating master cells.

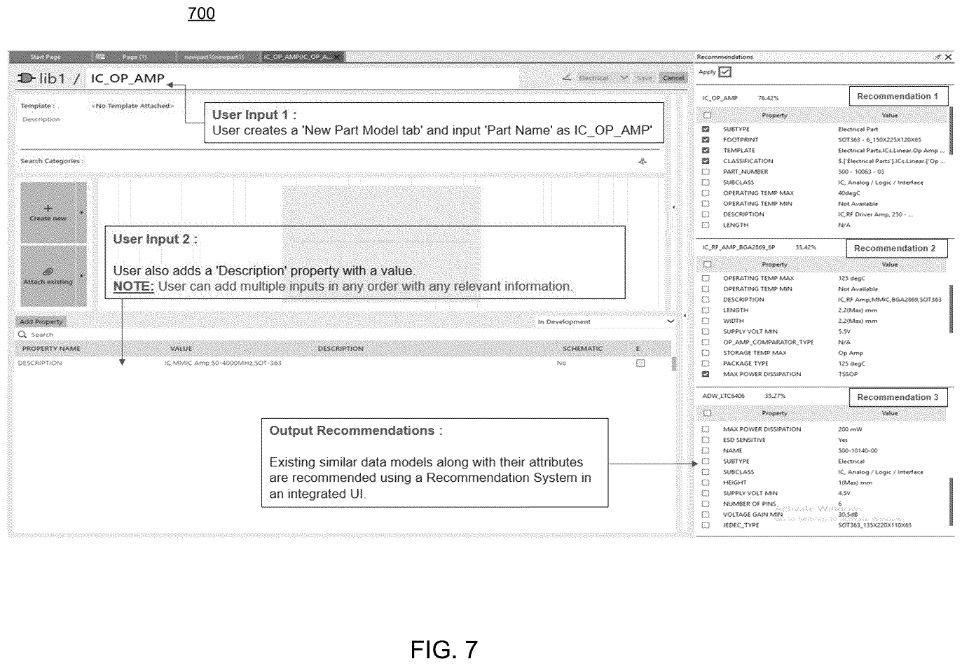

Referring now to FIGS. 7-20, embodiments consistent with library creation process 10 are provided. Embodiments included herein may provide a comprehensive solution for recommending data models of different types either graphical or non-graphical intuitively in the target library creator tool in a unified way.

In some embodiments, for all models (both graphical and non-graphical) the user may input one or more text properties, including, but not limited to, description, package type, subtype, name, JEDEC type, template name, classifications, etc. or numerical properties like tolerance, frequency, impedance etc. in a new data model being created for triggering recommendations. The user input data points may have partial or complete information.

In some embodiments, for graphical models, the indirect user inputs may include, but are not limited to, number of sections, pin number information, number of graphical symbols created, actual graphics created (deduced to number of lines, their intersections, type of shapes used, number of replicated shape types, their coordinate arrangements) will be used in a new data model being created for triggering recommendations. The indirect user input data points may have partial or complete information. The graphical inputs from the user may include library symbols and other graphical attributes. The number of symbols created, their attributes and which section they are assigned to may indirectly provide a number of sections, part type and other important features which may be used for fetching recommendations from the machine learning model (e.g., indirect user inputs).

In some embodiments, the resulting recommendations may recommend any suitable type of library data models including part models, schematic models, footprint models, etc. Recommendations may be made from existing library data models of a similar type as enquired from the one being created having some data input from library designer. Automated recommendations may be shown in an intuitive user interface widget having existing data model information such as their identifiers and properties which can be selected and applied to the current model being created.

In some embodiments, some or all of the aspects of library creation process 10 may be used with any front-end solution due to an inter-operable, flexible and modular architecture. Embodiments may also work with any front-end libraries database that may be used for making recommendations.

Referring now to FIG. 7, a graphical user interface 700 showing a part model example consistent with embodiments of the present disclosure is provided. As shown in user interface 700 a user may create a new part model tab and input a part name as “IC_OP_AMP”. The user may add a description property with a value. It should be noted that the user may add multiple inputs in any order with any relevant information. A recommendations panel may be configured to display one or more existing similar data models along with their attributes, which may be recommended using a recommendation system in an integrated user interface.

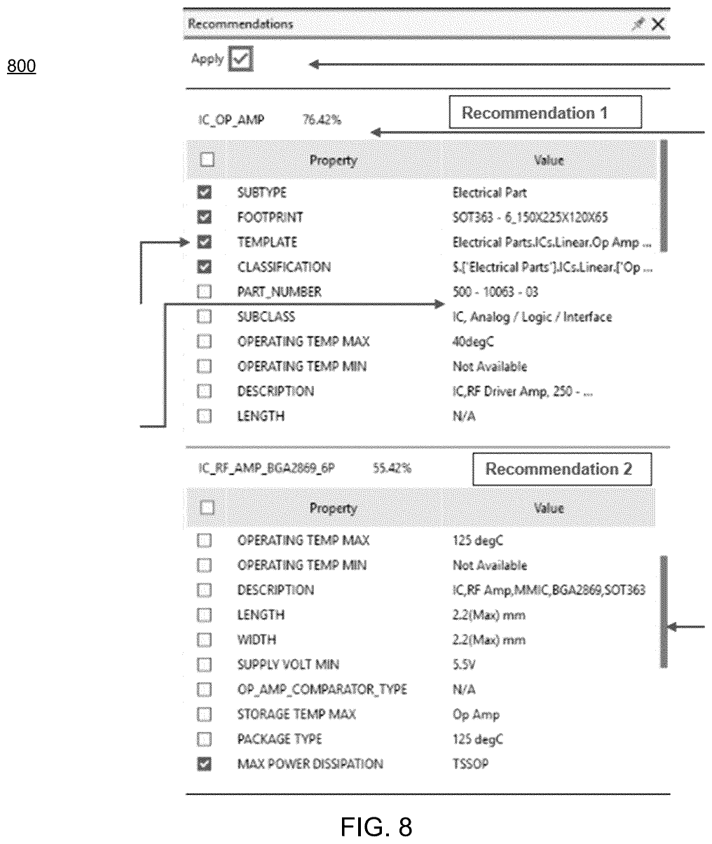

Referring now to FIG. 8, a graphical user interface 800 showing a recommendations user interface example consistent with embodiments of the present disclosure is provided. As shown in user interface 800 the recommendations user interface may show the recommended data models like part, schematic, footprint models, etc. in the order of decreasing similarity. Each row in the recommendation table may include 3 columns, namely checkbox, property name and value. A checkbox may be selected to apply a property and its value to current model being created. The value cell may include text, graphics or a hyperlink. Selecting a hyperlink value may open the linked model data in a new tab for detailed view and clicking on graphics will open a graphics previewer. Graphical values may include, but are not limited to, symbols, footprints, padstacks, etc. One or more properties can be selected from one or more suggested models aiding in the quick creation of a new library data model. An “Apply Button” may be provided, which when selected may apply all the selected properties to the library data model for which recommendations are shown. A similarity score percentage (SSP) specifying how much similar this data model is based on the new data model user input information (e.g., 76.42% shown in FIG. 8).

In some embodiments, mutually exclusive or contradictory properties within or across different model suggestions may be disabled (e.g., greyed out, etc.). After the recommended properties are applied, new recommendations may show up based on newly applied properties. Properties that are already applied may be filtered out from the new set of suggestions. One or more vertical scrollbars may appear to scroll through the list of recommendations, to scroll through a list of properties for each recommendation, etc.

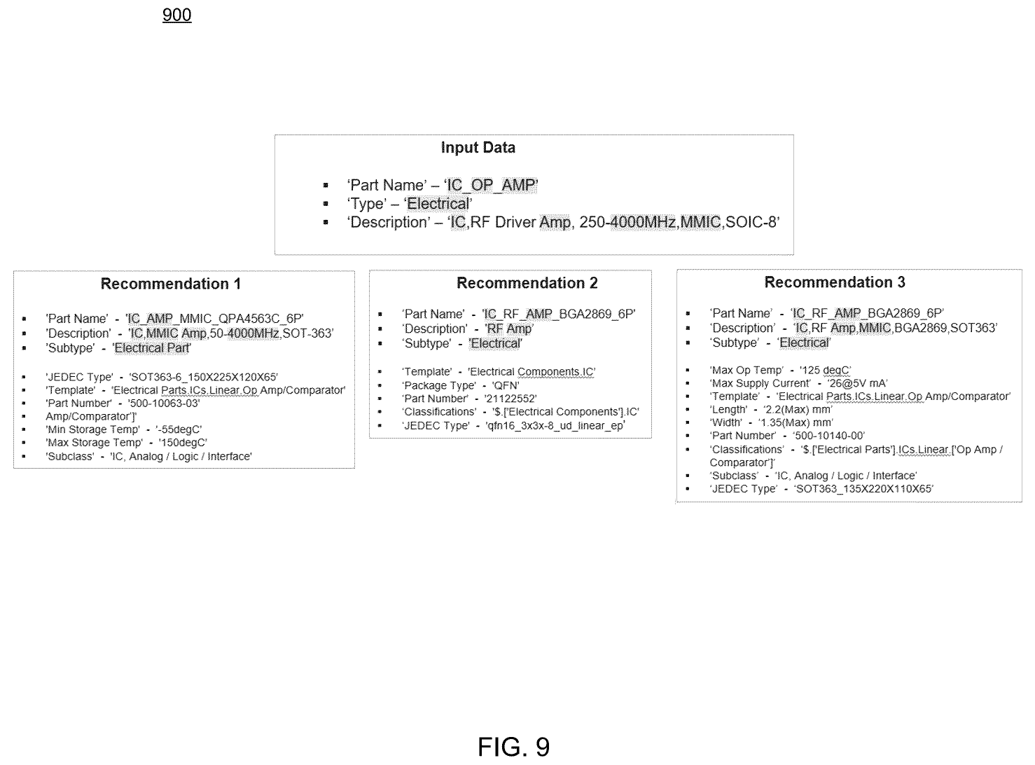

Referring now to FIG. 9, a diagram 900 showing a recommendations verification example (e.g., part model) consistent with embodiments of the present disclosure is provided. In this particular example, the highlighted text clearly denotes that library creation process 10 may work accurately in generating recommendations.

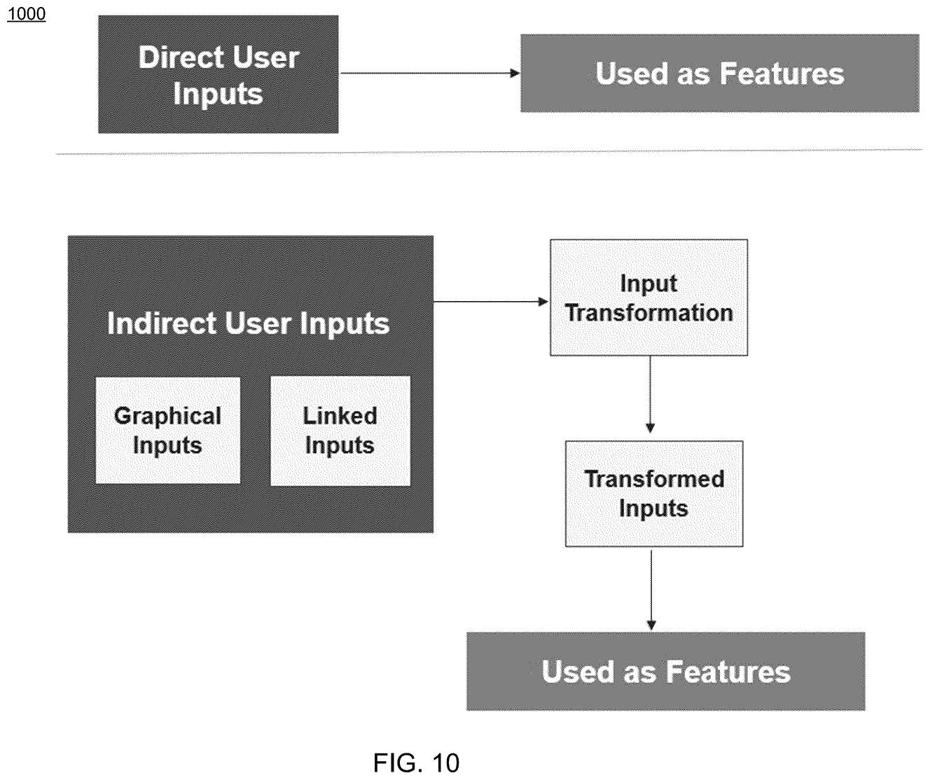

Referring now to FIG. 10, a diagram 1000 showing direct and indirect types of user inputs consistent with embodiments of the present disclosure is provided. In some embodiments, user inputs for library data model creation may be inferred as either direct or indirect. Direct user inputs may refer to those that may be directly treated as features. For example, properties such as frequency, tolerance, description etc. Indirect user inputs may refer to those that may be transformed to direct inputs by input transformation. With a graphical input, a user may create a schematic model symbol. In this case, a number of sections, a type of symbol (homogenous or heterogenous), a number of lines and their intersections, type of shapes used, a number of replicated shape types, their coordinate arrangements may be used as features.

In some embodiments, one or more library data models may include one or more linked data models. For example, a part model may include a linked, footprint, schematic, datasheet and padstack models. When a user links any library model with a current library model being created, those links may be extracted into features. For example, a linked footprint model's type and attributes may be used as features to recommend parts, which have a linking to a similar footprint model.

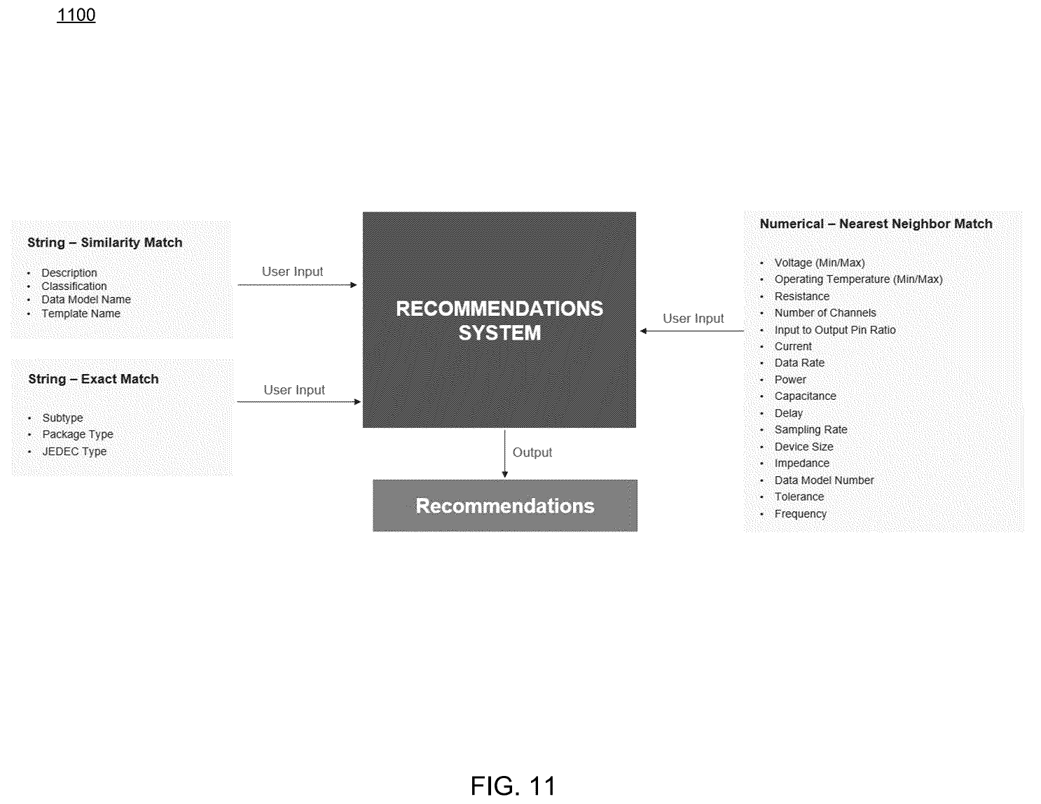

Referring now to FIG. 11, a diagram 1100 showing categories of user inputs (for multiple models) consistent with embodiments of the present disclosure is provided. In some embodiments, user inputs (e.g., direct or indirect) for library data model creation may be further categorized into one or more category types. Some of these may include, but are not limited to, string (exact match), string (similarity match), and number (nearest neighbor match). With a string (exact match) the recommendations resulting from these user inputs may based on an exact match or 1 or more occurrence of input values. With a string (similarity match) recommendation resulting from these user inputs may be based on partial or complete similarity matching of words in any order. With a number (nearest neighbor match): recommendations resulting from these user inputs may be based on nearest values. Each category of user input may have different intelligent EDA semantic search techniques to filter results for generating recommendations.

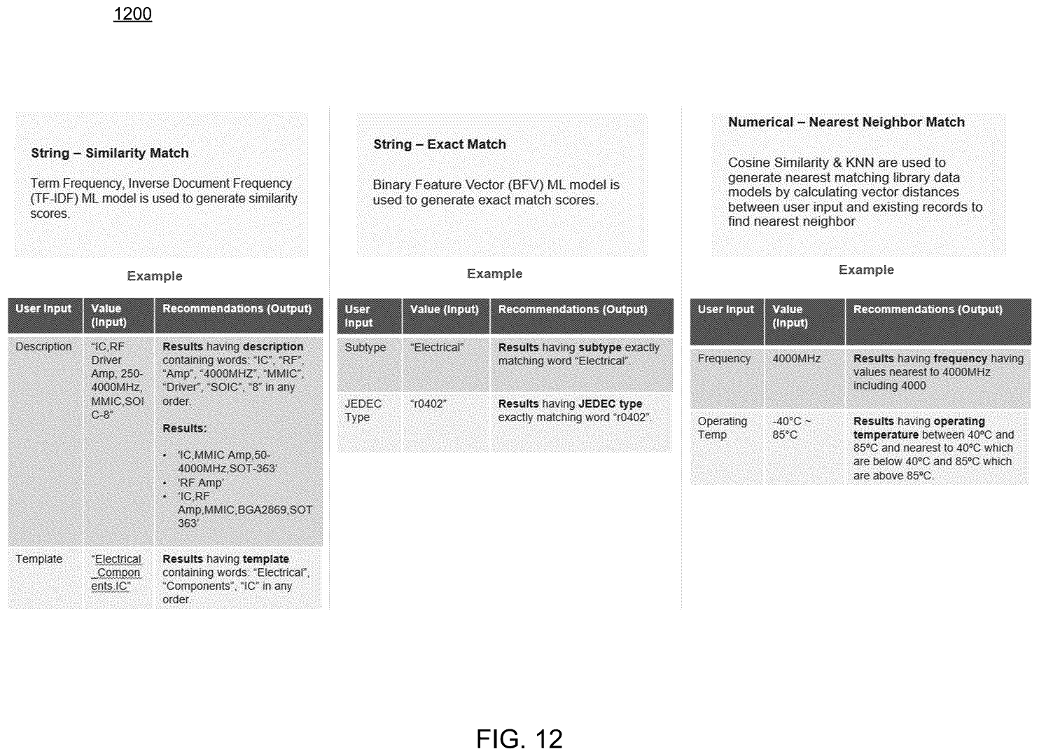

Referring now to FIG. 12, a diagram 1200 showing an example of intelligent EDA semantic search techniques consistent with embodiments of the present disclosure is provided. Specific examples for the similarity match, exact match, and nearest neighbor match are shown in FIG. 12.

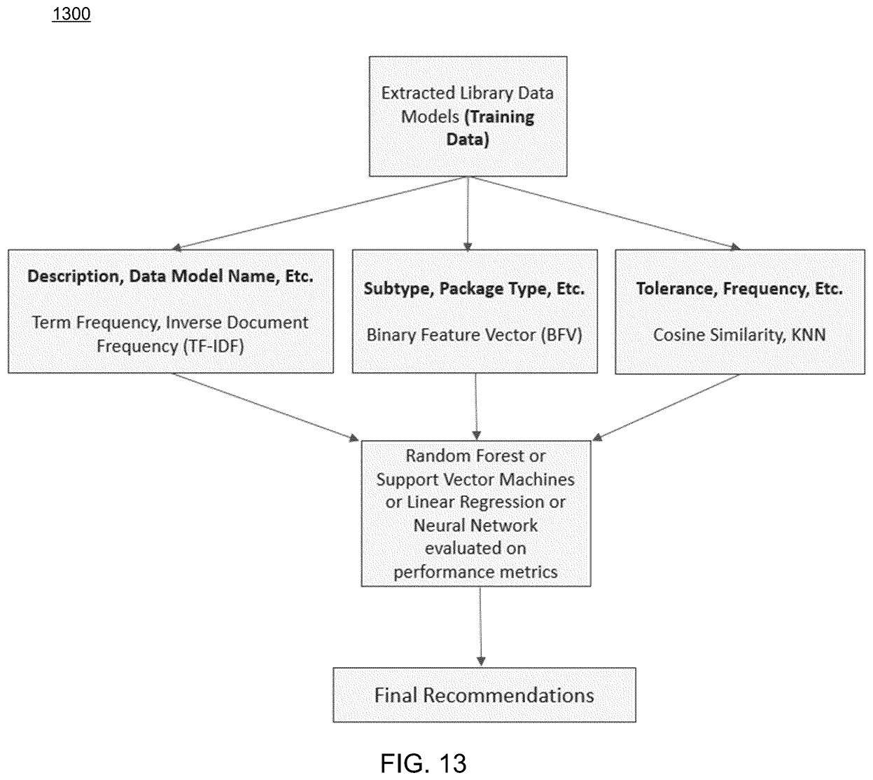

Referring now to FIG. 13, a flowchart 1300 depicting an embodiment in accordance with library creation process 10 is provided. This particular embodiment shows an example of stacking ensemble learning. Different machine learning models may be used for different sets of input features and may have their predictions combined using a machine learning technique known as ensemble learning. Stacked generalization may be used for combining prediction of multiple machine learning models. Same training data set may be used to train multiple machine learning models termed as ensemble learners or level-0 models on different feature set. Another meta-model also known as level-1 model may be trained that may take the cross-folded alteration of the underlying models as input (features) as well as the input training set to level-0 models and make the final prediction. This model may keep on learning as to how best combine the predictions of level-0 models. Meta-Model evaluation happens based on any number of metrics, some of which may include, but are not limited to, Mean Absolute Error (MAE), Accuracy Percent (Accuracy %), Mean Squared Error (MSE), etc.

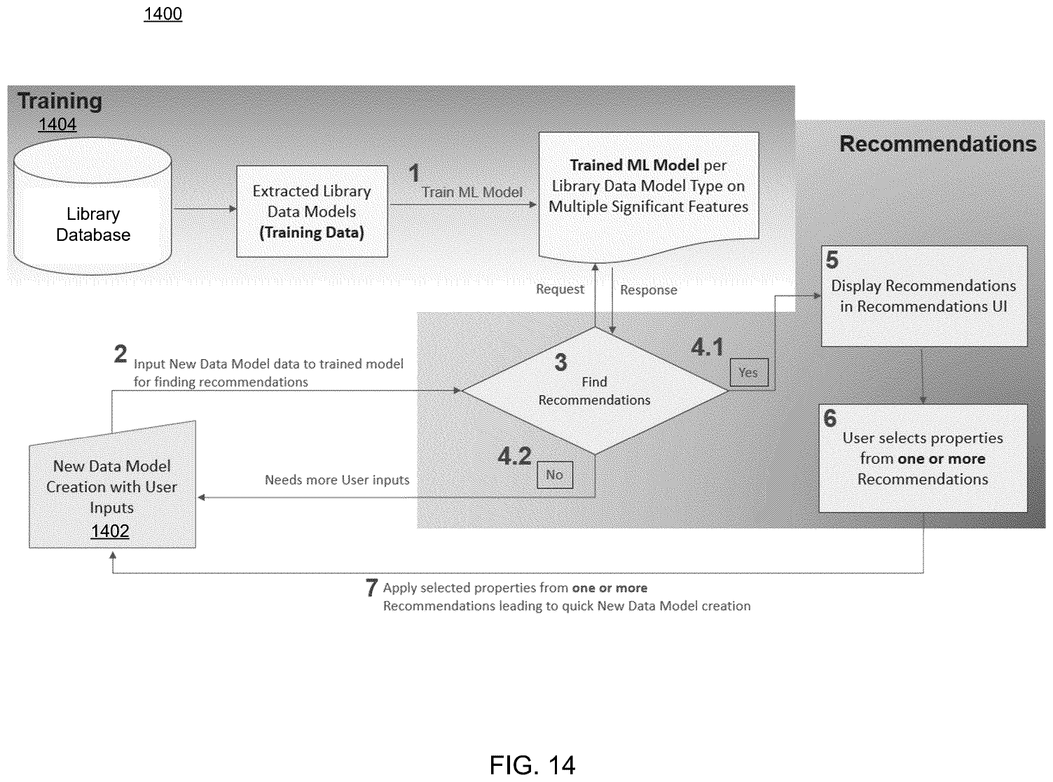

Referring now to FIG. 14, a flowchart 1400 depicting an embodiment in accordance with library creation process 10 is provided. This particular flowchart shows a machine learning model training example. The process may begin with the user initiating 1402 a new library data model creation and add some inputs. During training 1404 a library database that stores library data models may be accessed. A software program that uses one or more APIs to query all the library data models stored in database as they will form the basis of training our machine learning model. Once all the data is queried from the library database, the data may be cleaned-up, processed and prepared for training. First, the relevant features are extracted from the existing library data models (e.g., the features in FIG. 11) and then they are used to train various machine learning models depending upon the category of feature. This training zone work may be performed prior to anything else and before deploying this solution at any customer end. The application is provided in the recommendations portion of FIG. 14. This is where the application of the machine learning model may occur. Once the trained machine learning model is obtained, that may be used to generate recommendations. The user input(s) from new data model 1402 may be collected and fed into the machine learning model to find recommendations. If there are sufficient and relevant user inputs that trigger the machine learning model for any valid recommendations, then recommendations may be fetched from the machine learning model and displayed in a recommendations user interface as is shown in FIG. 8. Now, the user may choose one or more properties from one or more recommendations displayed in the Recommendations user interface (e.g., in the FIG. 8 checkboxes, etc.) and those may be applied to the new model being created. On application of recommended data (e.g., using the apply button in FIG. 8), new recommendations may be fetched as there are more user inputs now (e.g., newly applied properties) narrowing down the recommendations to more similarity percentage matches.

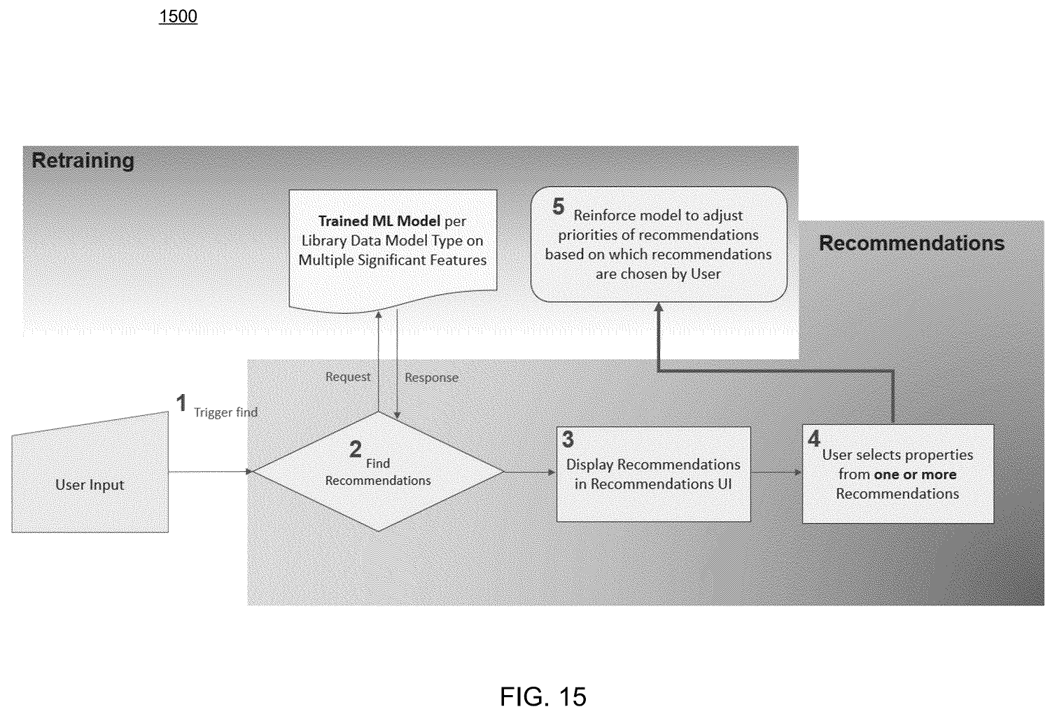

Referring now to FIG. 15, a flowchart 1500 depicting an embodiment in accordance with library creation process 10 is provided. This particular flowchart shows a machine learning model re-training example. Flowchart 1500 includes some similar elements as the previous flowchart but also includes a retraining element. Assuming that the user has selected one or more properties from multiple recommendations. Based on what the user is selecting the machine learning model may be retrained to adjust the priorities of recommendations. If the user has selected some properties from a recommendations, which was just 10% matching in similarity whereas recommendations which have 50% match are also there, it may indicate that perhaps the 10% match recommendation was more useful to the user instead of the 50% match. The machine learning model may now be retrained to reprioritize recommendations.

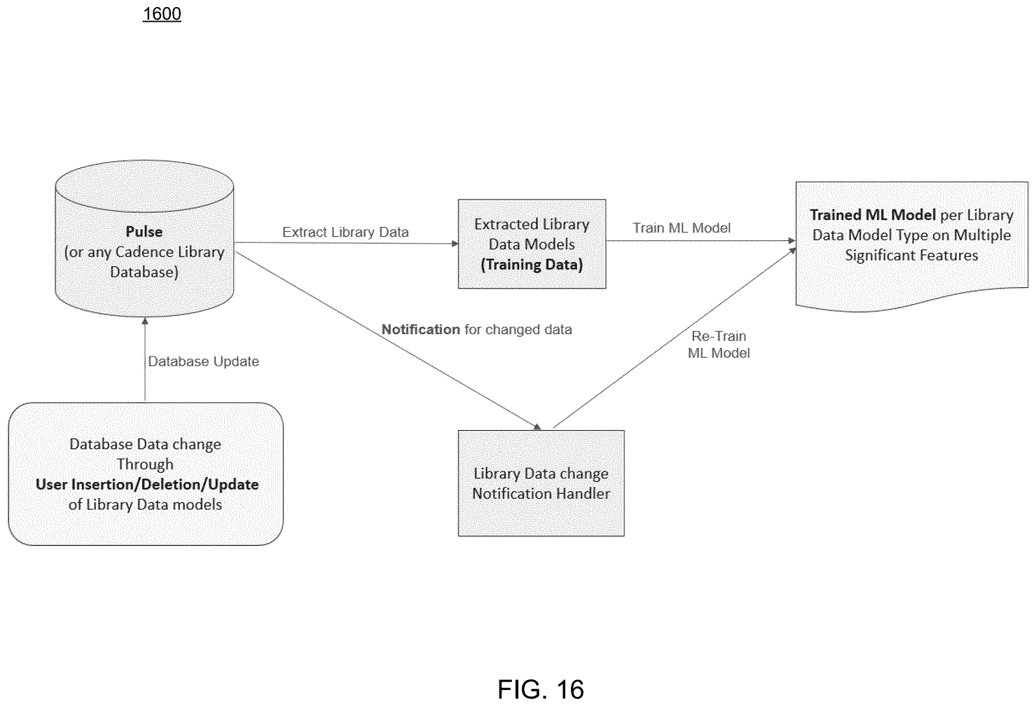

Referring now to FIG. 16, a flowchart 1600 depicting an embodiment in accordance with library creation process 10 is provided. This particular flowchart shows an example of the continuous training of a machine learning model. Flowchart 1600 explains the communication architecture between various modules when there is any change in database 1402. When a new library data model is added, when an existing library data model is deleted or updated, the machine learning model needs to be re-trained, otherwise, the recommendations shown from the machine learning model may be outdated with respect to latest database. Flowchart 1600 explains how the notifications are triggered.

In some embodiments, when any database change happens, it may release a notification of “Library Data Change” which may be handled by a “Notification Handler”, which is part of the recommendation system. The notification handler, upon receiving appropriate notification from the database, may trigger a re-training of the machine learning model with the changed database data so that the latest snapshot of existing library data in database 1402 may be provided to the user in terms of recommendations in recommendations user interface.

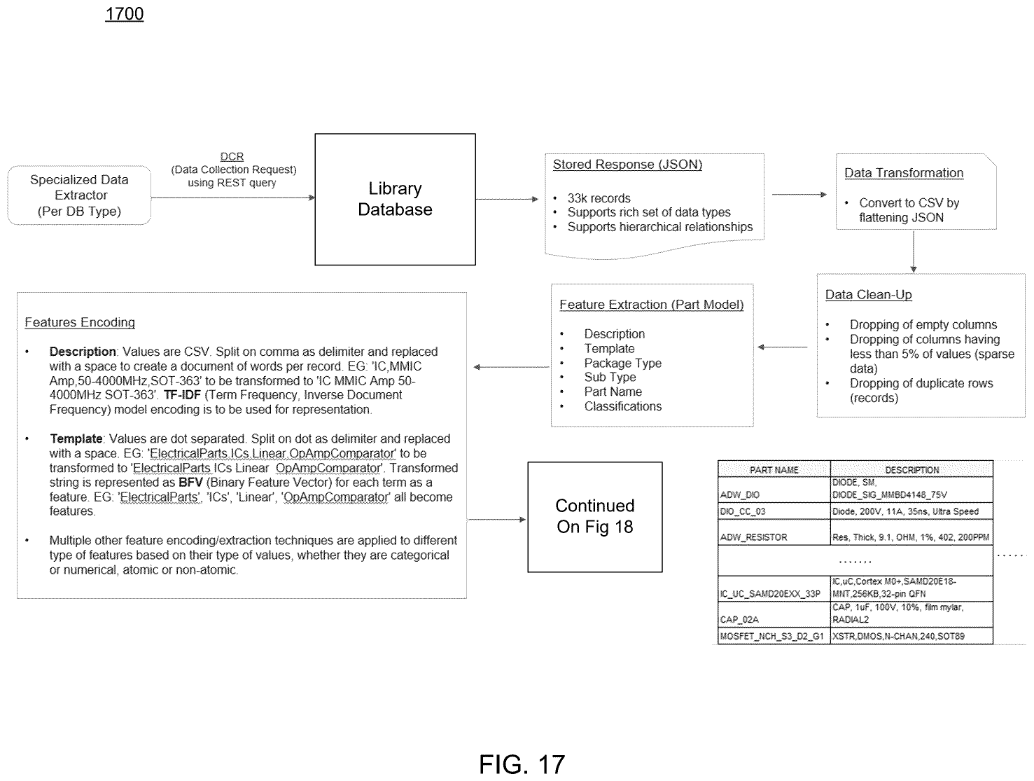

Referring now to FIG. 17, a diagram 1700 depicting an embodiment in accordance with library creation process 10 is provided. This particular flowchart shows machine learning model details including a methodology for features encoding. In some embodiments, for the description, values may take any form such as CSV. Split on comma as delimiter and replaced with a space to create a document of words per record. For example, “IC, MMIC Amp,50-4000 MHz, SOT-363” may be transformed to “IC MMIC Amp 50-4000 MHz SOT-363”. TF-IDF (Term Frequency, Inverse Document Frequency) model encoding is to be used for representation.

In some embodiments, for the template, values may be dot separated. Split on dot as delimiter and replaced with a space. For example, “ElectricalParts.ICs.Linear.OpAmpComparator” may be transformed to “ElectricalParts ICs Linear OpAmpComparator”. A transformed string may be represented as BFV (Binary Feature Vector) for each term as a feature. For example, “ElectricalParts”, “ICs”, “Linear”, “OpAmpComparator” all become features. Multiple other feature encoding/extraction techniques may be applied to different type of features based on their type of values, whether they are categorical or numerical, atomic or non-atomic.

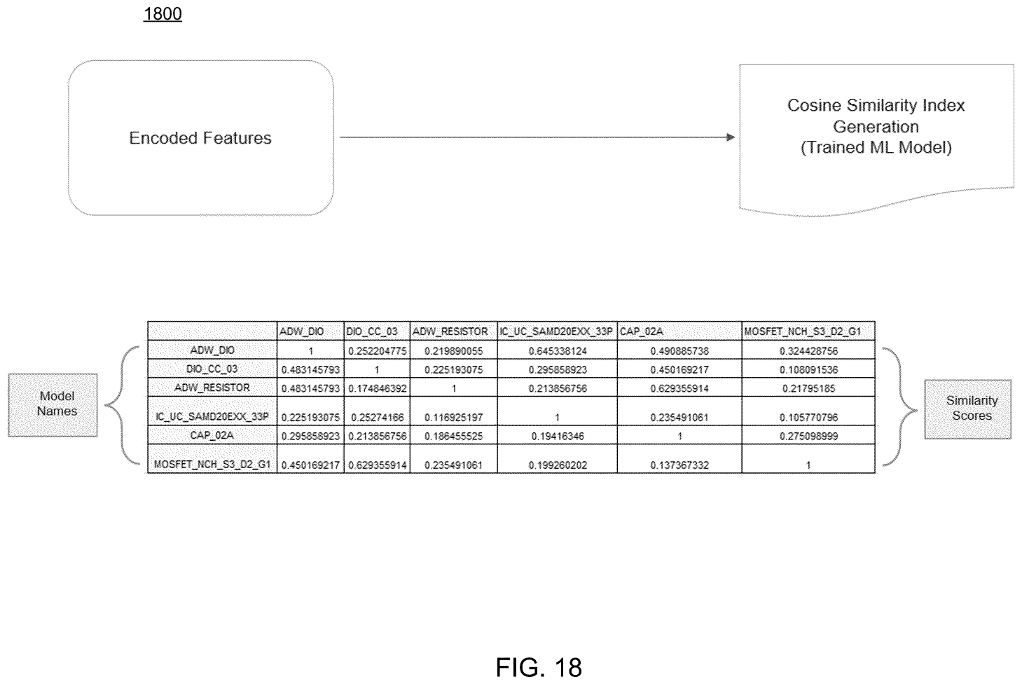

Referring now to FIG. 18, a diagram 1800 depicting an embodiment in accordance with library creation process 10 is provided. Diagram 1800 shows an example including exemplary machine learning model details. In this particular example, numbers may denote the similarity index between any two data models. Higher numbers indicate greater similarity and lower numbers indicate lesser similarity. For a new data model being created, recommendations may be based out of this similarity matrix.

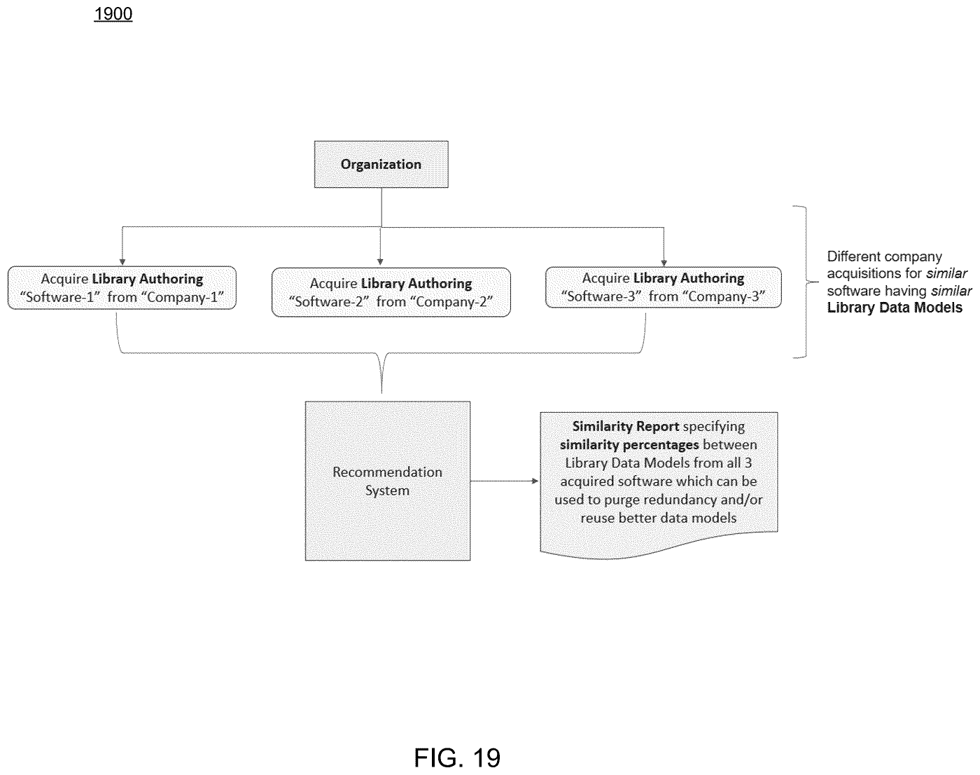

Referring now to FIG. 19, a flowchart 1900 depicting an embodiment in accordance with library creation process 10 is provided. Flowchart 1900 shows an example for similarity reports generation. Flowchart 1900 is describing the novelty and usefulness in case an organization has acquired library authoring tools from different acquisitions. EDA companies may often be involved in a number of acquisitions of companies which offered library Authoring tools for library data model creation. Generically, if an organization now has four different tools that perform the same job of library data model creation and have four databases having library data models in their formats, it becomes very important to analyze and compute if there are any redundant data models. Recommendations system when trained on four different databases acquired from four different acquisitions of four different companies may help generate a similarity report which may clearly what all is similar across four different databases in terms of library data models.

Embodiments of the library creation process described herein may generate intuitive in-context recommendations based on the user inputs which can be any property or set of properties like description, template name, tolerance, operating temperature, JEDEC_TYPE, section count, etc. Embodiments included herein may work with both front-end and back-end library data models. In operation, a user may choose any one complete recommendation or may choose required properties from the combination of multiple recommendations to create a fully functional library data model. User selection of recommendations may automatically provide a reinforcement learning basis of the machine learning model. For example, if a user has selected five properties from the second recommendation and three from the first recommendation, the system may sophisticatedly retrain itself that second recommendation is better than the first recommendation. Continuous incremental recommendations may be shown based on changing input data in the new library data model being created. For example, if one property was input initially and three were chosen from the recommendations, new suggestions may show up based on four properties now. This facilitates on-the-fly data model creation.

Embodiments included herein may be scalable to all library data models, some of which may include, but are not limited to, part model, schematic model, step-model, padstack model, footprint model or any other model because of per-model training of the machine learning model and recommendations result in a generic recommendation graphical user interface. Library creation process included herein may help purge redundant data models already found in the existing eco-system as shown in recommendations and may also be used to augment search system capabilities easing down the efforts of schematic engineers in searching library data models.

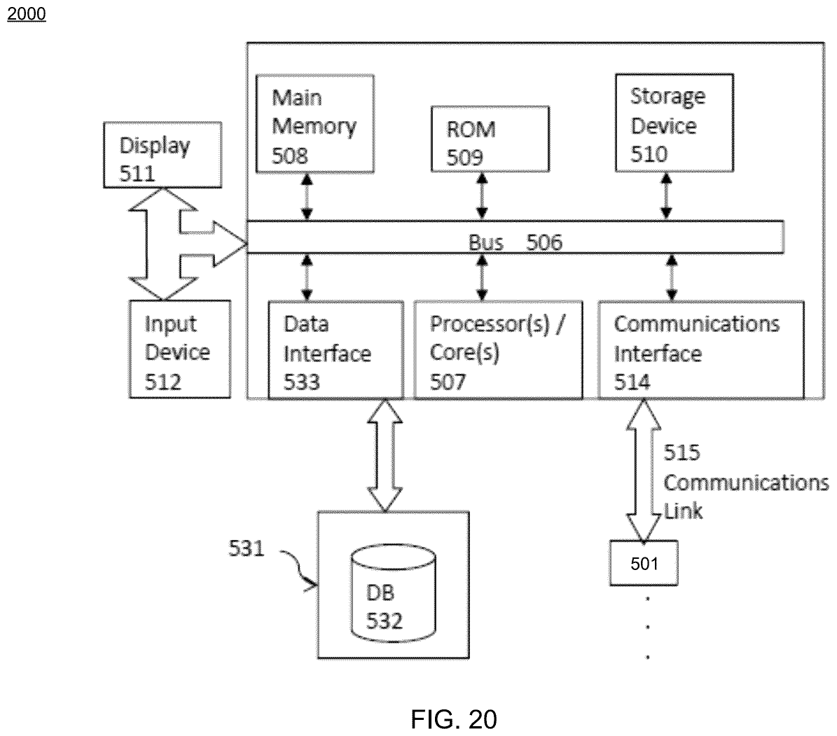

FIG. 20 illustrates a block diagram of an illustrative computing system 500 suitable for concurrent electrical component placement as described in the preceding paragraphs with reference to various figures. Computer system 501 includes a bus 506 or other communication mechanism for communicating information, which interconnects subsystems and devices, such as processor 507, system memory 508 (e.g., RAM), static storage device 509 (e.g., ROM), disk drive 510 (e.g., magnetic or optical), communication interface 514 (e.g., modem or Ethernet card), display 511 (e.g., CRT or LCD), input device 512 (e.g., keyboard), and cursor control (not shown).

According to one embodiment, computing system 501 performs specific operations by one or more processor or processor cores 507 executing one or more sequences of one or more instructions contained in system memory 508. Such instructions may be read into system memory 508 from another computer readable/usable storage medium, such as static storage device 509 or disk drive 510. In alternative embodiments, hard-wired circuitry may be used in place of or in combination with software instructions to implement the invention. Thus, embodiments of the invention are not limited to any specific combination of hardware circuitry and/or software. In one embodiment, the term “logic” shall mean any combination of software or hardware that is used to implement all or part of the invention.

Various actions or processes as described in the preceding paragraphs may be performed by using one or more processors, one or more processor cores, or combination thereof 507, where the one or more processors, one or more processor cores, or combination thereof executes one or more threads. For example, various acts of identifying, various acts of determining, various acts of classifying, various acts of implementing, various acts of performing, various acts of transforming, various acts of decomposing, various acts of updating, various acts of presenting, various acts of modifying, etc. may be performed by one or more processors, one or more processor cores, or combination thereof.

A mechanism described herein may also be implemented as a pure hardware module (e.g., a block of electronic circuit components, electrical circuitry, etc.) or a combination of a hardware module and a software block that jointly perform various tasks to achieve various functions or purposes described herein or equivalents thereof. For example, a mechanism described herein may be implemented as an application-specific integrated circuit (ASIC) in some embodiments.

In these embodiments, a mechanism may thus include, for example, a microprocessor or a processor core and other supportive electrical circuitry to perform specific functions which may be coded as software or hard coded as a part of an application-specific integrated circuit, ROM (read only memory), PROM (programmable read only memory), EPROM (erasable programmable read only memory), etc. despite the fact that these microprocessor, processor core, and electrical circuitry may nevertheless be shared among a plurality of mechanism. A mechanism described herein or an equivalent thereof may perform its respective functions alone or in conjunction with one or more other mechanisms. A mechanism described herein or an equivalent thereof may thus invoke one or more other mechanisms by, for example, issuing one or more commands or function calls. The invocation of one or more other mechanisms may be fully automated or may involve one or more user inputs.

The term “computer readable storage medium” or “computer usable storage medium” as used herein refers to any non-transitory medium that participates in providing instructions to processor 507 for execution. Such a medium may take many forms, including but not limited to, non-volatile media and volatile media. Non-volatile media includes, for example, optical or magnetic disks, such as disk drive 510. Volatile media includes dynamic memory, such as system memory 508. Common forms of computer readable storage media includes, for example, electromechanical disk drives (such as a floppy disk, a flexible disk, or a hard disk), a flash-based, RAM-based (such as SRAM, DRAM, SDRAM, DDR, MRAM, etc.), or any other solid-state drives (SSD), magnetic tape, any other magnetic or magneto-optical medium, CD-ROM, any other optical medium, any other physical medium with patterns of holes, RAM, PROM, EPROM, FLASH-EPROM, any other memory chip or cartridge, or any other medium from which a computer can read.

In an embodiment of the invention, execution of the sequences of instructions to practice the invention is performed by a single computer system 500. According to other embodiments of the invention, two or more computer systems 500 coupled by communication link 515 (e.g., LAN, PTSN, or wireless network) may perform the sequence of instructions required to practice the invention in coordination with one another.

Computer system 500 may transmit and receive messages, data, and instructions, including program, e.g., application code, through communication link 515 and communication interface 514. Received program code may be executed by processor 507 as it is received, and/or stored in disk drive 510, or other non-volatile storage for later execution. In an embodiment, the computing system 500 operates in conjunction with a data storage system 531, e.g., a data storage system 531 that includes a database 532 that is readily accessible by the computing system 500. The computing system 500 communicates with the data storage system 531 through a data interface 533. A data interface 533, which is coupled with the bus 506, transmits and receives electrical, electromagnetic or optical signals that include data streams representing various types of signal information, e.g., instructions, messages and data. In embodiments of the invention, the functions of the data interface 533 may be performed by the communication interface 514. It also should be appreciated that the computer system 500 may be extended to a cloud-based computing system.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

1. A computer-implemented method, comprising:
receiving, at a graphical user interface, a user input related to a library data model;
analyzing a trained machine learning model based upon, at least in part, the user input;
providing, at the graphical user interface, one or more recommendations for the user input; and
receiving, at the graphical user interface, a first selection of the one or more recommendations.

2. The method of claim 1, further comprising:
generating a new data model based upon, at least in part, the selection.

3. The method of claim 1, wherein the library data model is a graphical data model.

4. The method of claim 1, wherein the library data model is a non-graphical data model.

5. The method of claim 1, wherein the user input is a textual input.

6. The method of claim 1, wherein the user input is a graphical input.

7. The method of claim 1, further comprising:
receiving, at the graphical user interface, a second selection of a second of the one or more recommendations.

8. The method of claim 7, wherein the first selection and the second selection are from different library models.

9. The method of claim 1, wherein the one or more recommendations are displayed in an order of prioritized relevancy.

10. The method of claim 1, further comprising:
providing, at the graphical user interface, an option to reject a proposed recommendation to provide negative feedback.

11. The method of claim 1, wherein the library data model is at least one of a front-end model or a back-end model.

12. The method of claim 1, further comprising:
retraining the machine learning model based upon, at least in part, the first selection.

13. The method of claim 1, further comprising:
providing, at the graphical user interface, an option to purge redundant data.

14. A system comprising:
at least one processor configured to cause receiving, at a graphical user interface, a user input related to a library data model, the at least one processor further configured to analyze a trained machine learning model based upon, at least in part, the user input and to provide, at the graphical user interface, one or more recommendations for the user input, the at least one processor further configured to cause receiving, at the graphical user interface, a first selection of the one or more recommendations.

15. The system of claim 14, generating a new data model based upon, at least in part, the selection.

16. The system of claim 14, wherein the library data model is a graphical data model.

17. The system of claim 14, wherein the library data model is a non-graphical data model.

18. The system of claim 14, wherein the user input is a textual input.

19. The system of claim 14, wherein the user input is a graphical input.

20. A non-transitory computer readable storage medium having stored thereon one or more instructions, which when executed by a processor result in one or more operations, the operations comprising:
receiving, at a graphical user interface, a user input related to a library data model;
analyzing a trained machine learning model based upon, at least in part, the user input;
providing, at the graphical user interface, one or more recommendations for the user input; and
receiving, at the graphical user interface, a first selection of the one or more recommendations.
